(19) United States
(12) Patent Application Publication
(10) Pub. No.: US 2026/0241543 A1
(43) Pub. Date: Aug. 20, 2026

(54) ELECTRONIC ASSISTIVE LIFTING APPARATUS AND METHOD OF USE

(71) Applicant: Wendy Meyer, Aurora, CO (US)

(72) Inventor: Wendy Meyer, Aurora, CO (US)

(21) Appl. No.: 19/434,752

(22) Filed: Dec. 29, 2025

Related U.S. Application Data
(60) Provisional application No. 63/760,709, filed on Feb. 20, 2025.

(51) Int. Cl. B25J 9/00

(52) U.S. Cl. CPC B25J 9/0006

(57) ABSTRACT

An electronic assistive lifting apparatus designed as a wearable exoskeleton to reduce muscular strain during lifting tasks is disclosed. The apparatus can include a harness strap assembly for distributing load forces across the upper body, and an arm-assist module having upper arm and forearm braces connected by a joint assembly with a rotational hinge. The system incorporates sensors to detect angular displacement, load, and motion, and electromechanical actuators configured to generate synchronized lifting assistance. An electronic control module having a microcontroller, interface, sensors, and rechargeable power source processes sensor signals to determine user motion intent and generates control outputs for the actuators. The apparatus dynamically adjusts actuator response in real time, ensuring coordinated, natural movement.

### CROSS-REFERENCE TO RELATED APPLICATION

The present application claims priority to, and the benefit of, U.S. Provisional Application No. 63/760,709 which was filed on Feb. 20, 2025 and is incorporated herein by reference in its entirety.

### FIELD OF THE INVENTION

The present invention generally relates to assistive devices. More specifically, the present invention relates to an electronic assistive lifting apparatus designed to help users lift heavy objects with minimal physical strain. The invention comprises a multi-component wearable assembly that can include a harness strap member configured to be worn about the upper torso of a user or wearer to distribute load forces evenly across the shoulders, chest, and back. An arm-assist module can be connected to a harness strap connected to the harness strap member and includes an upper arm brace and a forearm brace, each having adjustable straps and rigid or semi-rigid support frames that conform to the user’s anatomy. A joint assembly positioned proximally to the elbow region connects the two braces and incorporates a rotational hinge for smooth articulation and one or more sensors configured to detect motion and load parameters. The system further includes a plurality of electromechanical actuators operatively coupled to the joint assembly and support frames, generating mechanical lifting assistance during operation. An electronic control module provides power and control, including a microcontroller, battery pack, and user interface, enabling manual or automatic activation and real-time feedback adjustment to ensure efficient, safe, and natural lifting assistance. Accordingly, the present disclosure makes specific reference thereto. Nonetheless, it is to be appreciated that aspects of the present invention are also equally applicable to other like applications, devices, and methods of manufacture.

### BACKGROUND

By way of background, lifting heavy objects in everyday situations, such as at home, in workplaces, during transportation, or while moving, commonly poses significant physical challenges for many individuals. Repeated or improper lifting can lead to fatigue, muscle strain, and long-term physical discomfort. Over time, such activities may contribute to more serious musculoskeletal injuries, including back pain, shoulder strain, joint stress, or even hernias. In severe cases, individuals may require medical interventions such as surgery or long-term rehabilitation to recover from the damage caused by lifting heavy loads.

Traditional lifting techniques and available supportive equipment, such as manual braces or basic assistive straps, often provide only limited relief and fail to reduce the physical effort required for lifting. As a result, individuals desire a technological solution that can assist users in lifting heavy objects more safely and efficiently while minimizing muscular exertion, fatigue, and injury risk.

Therefore, there exists a long-felt need in the art for an improved system and method for assisting individuals in lifting heavy objects while minimizing physical strain, fatigue, and injury risk. There is a need for an intelligent, wearable lifting device that can augment a user’s natural strength through powered assistance, enabling efficient and safe handling of heavy objects. Furthermore, there exists a need for a device that is lightweight, comfortable, and capable of continuous operation throughout the day without restricting natural movement. Additionally, there is a need for a lifting apparatus that integrates electronic control and feedback to dynamically respond to the user’s motion and provide precisely calibrated assistance during lifting activities. Finally, there is a need for an apparatus that reduces the chance of aches, pain, and injury commonly associated with lifting heavy items and objects.

The subject matter disclosed and claimed herein, in one embodiment, comprises an electronic assistive lifting apparatus designed to provide powered lifting assistance to users while maintaining ergonomic comfort and natural mobility. The apparatus can comprise of a harness strap constructed from lightweight, high-tensile materials configured to distribute lifting loads evenly across the torso, shoulders, and back of the user. An arm-assist module can be connected to a harness strap and includes an upper arm brace and a forearm brace that conform to the user’s anatomy. The braces are connected by a joint assembly incorporating a rotational hinge that enables smooth articulation at the elbow region. Integrated sensors are configured to detect parameters such as angular displacement, torque, strain, and load. Electromechanical actuators coupled to the joint assembly are configured to provide controlled mechanical assistance synchronized with the natural movement of the user’s arm.

In one embodiment, the apparatus further includes an electronic control module (ECM) that functions as the central processing and power distribution system of the device. The ECM houses a microcontroller, one or more sensors, a user interface, and a rechargeable power source. The microcontroller receives input signals from the sensors, executes motion control algorithms, and generates actuation commands to the electromechanical actuators. The user interface enables manual or automatic activation of the apparatus and can include control buttons, indicators, or wireless communication modules.

In this manner, the electronic assistive lifting apparatus of the present invention overcomes long-standing deficiencies in the art by providing a lightweight, ergonomic, and electronically powered exoskeleton system that reduces the biomechanical strain associated with lifting heavy objects. The invention enhances lifting capability by transferring a portion of the required lifting force from the user’s muscles to an intelligent, motor-driven mechanism controlled by real-time sensor feedback. The apparatus operates as a closed-loop adaptive system that synchronizes with the user’s motion, ensuring stable, natural, and fatigue-free lifting performance. The device can be employed in various applications including industrial work, warehouse operations, home environments, and healthcare settings.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an electronic assistive lifting apparatus designed to aid a user in lifting heavy objects while minimizing muscular effort. The apparatus comprises a wearable exoskeleton structure that can include a harness strap member configured to be worn around the torso of the user. An arm-assist module is configured to be positioned along arm of a user or wearer and includes both a forearm brace and an upper arm brace. Each brace is equipped with adjustable straps and a rigid or semi-rigid support frame that conforms to the user’s anatomy for comfort and stability. A joint assembly located between the two support frames includes a rotational hinge that enables relative movement between the upper and lower arm portions. The apparatus further includes a plurality of sensors configured to detect angular displacement, torque, strain, acceleration, and load forces acting on the user’s arm. One or more electromechanical actuators are coupled to the joint assembly and are configured to provide mechanical lifting assistance synchronized with the user’s natural arm motion. The system is controlled by an electronic control module that communicates with the sensors and actuators to process sensor data and generate the control signals necessary to deliver coordinated lifting assistance.

The invention further provides an electronic control module that serves as the central processing and power distribution system of the lifting apparatus. The control module includes a protective housing formed of a lightweight and durable material, enclosing a microcontroller, sensors, interface, and power source. The microcontroller functions as the processing unit of the control system and is configured to receive input signals from sensors, execute control algorithms, and generate actuator control signals. The module includes one or more sensors for monitoring operational and biomechanical parameters such as angular displacement, torque, strain, acceleration, and load distribution. A user interface enables interaction between the user and the control module and can include control buttons, a touch panel, indicators, or wireless communication modules. The control module is powered by a rechargeable battery pack that provides electrical energy to both the controller and the actuators. During operation, the microcontroller processes motion data received from the sensors, generates control outputs for the actuators, and performs safety functions including power interruption in the event of overload or system fault detection.

In yet another embodiment, the apparatus includes one or more sensors configured to detect motion and load parameters corresponding to the arm movements of the user. A microcontroller within the electronic control module processes the sensor signals to determine the user’s motion intent and compute the appropriate level of mechanical assistance. The microcontroller employs advanced control algorithms, such as proportional–integral–derivative control or load-adaptive feedback control, to dynamically generate actuator commands. The control signals are transmitted to electromechanical actuators that deliver a proportional lifting force synchronized with the user’s arm movement.

In still another embodiment, a method for operating the electronic assistive lifting apparatus to assist a user in lifting heavy objects is described. The method begins with activating the apparatus, either manually through the control interface or automatically through motion detection by embedded sensors. Once activated, the sensors monitor the user’s arm movement and load forces during lifting. The signals generated by the sensors are processed by a microcontroller housed within the electronic control module to determine motion intent and required actuator torque. Based on the analysis, the microcontroller generates control signals using adaptive algorithms to achieve real-time coordination with the user’s movement. The control signals are transmitted to actuators, which produce synchronized mechanical lifting assistance that complements the natural motion of the user’s arm.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of electronic assistive lifting apparatus of the present invention in accordance with the disclosed structure;

FIG. 2 illustrates an embodiment of the electronic control module, which forms the central processing and power distribution mechanism of the lifting-assist device of the present invention in accordance with the disclosed structure;

FIG. 3 illustrates a perspective view of the electronic assistive lifting apparatus of the present invention being worn by a wearer for lifting heavy objects with minimal muscular effort; and

FIG. 4 illustrates a flow diagram depicting the operational sequence of the electronic assistive lifting apparatus, according to one embodiment of the present invention.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved system and method for assisting individuals in lifting heavy objects while minimizing physical strain, fatigue, and injury risk. There is a need for an intelligent, wearable lifting device that can augment a user’s natural strength through powered assistance, enabling efficient and safe handling of heavy objects. Furthermore, there exists a need for a device that is lightweight, comfortable, and capable of continuous operation throughout the day without restricting natural movement. Additionally, there is a need for a lifting apparatus that integrates electronic control and feedback to dynamically respond to the user’s motion and provide precisely calibrated assistance during lifting activities. Finally, there is a need for an apparatus that reduces the chance of aches, pain, and injury commonly associated with lifting heavy items and objects.

The present invention, in one exemplary embodiment, is an electronic assistive lifting apparatus designed to aid a user in lifting heavy objects while minimizing muscular effort. The apparatus can comprise of a harness strap configured to be worn around the torso of the user. An arm-assist module is configured to be positioned along arm of a user or wearer and includes both a forearm brace and an upper arm brace. Each brace is equipped with adjustable straps and a rigid or semi-rigid support frame. A joint assembly located between the two support frames includes a rotational hinge that enables relative movement between the upper and lower arm portions. The apparatus further includes a plurality of sensors configured to detect angular displacement, torque, strain, acceleration, and load forces acting on the user’s arm. One or more electromechanical actuators are coupled to the joint assembly and are configured to provide mechanical lifting assistance synchronized with the user’s natural arm motion. The system is controlled by an electronic control module that communicates with the sensors and actuators to process sensor data and generate the control signals necessary to deliver coordinated lifting assistance. The device is worn on both arms to evenly distribute weight. Further, the device is not limited by gender. Males and females will both appreciate the benefits of the device.

Reference will now be made in detail to the present preferred embodiments of the invention, examples of which are illustrated in the accompanying drawings. Wherever possible, the same reference numerals are used in the drawings and the description to refer to the same or like parts.

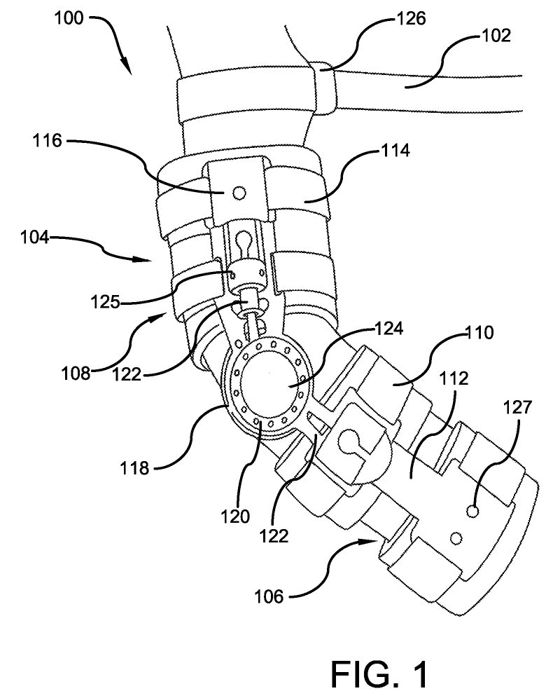

Referring initially to the drawings, FIG. 1 illustrates a perspective view of electronic assistive lifting apparatus of the present invention in accordance with the disclosed structure. The electronic assistive lifting apparatus 100 of the present invention is designed to help users lift heavy objects with minimal physical strain. Specifically, the electronic assistive lifting apparatus 100 functions as a wearable exoskeleton system that supports the arms (i.e., limbs) and shoulders, transferring the lifting force from muscles of the wearer of the apparatus 100 to the powered mechanisms built into the device.

The apparatus 100 can include a harness strap, and can be constructed from lightweight, high-tensile materials to distribute load forces evenly across the upper body of the wearer of the apparatus 100. It is to be appreciated that the harness strap can comprise of a selectively adjustable strap including a length adjuster and securement means, for example a hook and loop fastener (not illustrated). Specifically, the strap member 102 distributes the lifting forces across shoulders, back, and chest of the wearer. The harness strap member 102 is lightweight and adjustable and preferably made from breathable and durable materials such as reinforced nylon or carbon-fiber composites.

An arm-assist module 104 can be operatively connected to a harness strap member 102 and is configured to be positioned along an arm or limb of a user or wearer. The arm-assist module 104 includes a forearm brace 106 and an upper arm brace 108. The forearm brace 106 includes an adjustable strap 110 and has a rigid or semi-rigid support frame 112. Similarly, the upper arm brace 108 includes a corresponding adjustable strap 114 and has a rigid or semi-rigid support frame 116.

A joint assembly 118 is disposed between the support frames 112, 116 and is operatively connected to the support frames 112, 116. In operation, the joint assembly 118 is disposed proximally to the elbow region of the user wearing the apparatus 100. The joint assembly 118 includes a rotational hinge 120 enabling the rotational movement of the support frame 112 relative to the support frame 116. The joint assembly 118 also includes one or more sensors 122 configured to detect angular displacement and applied load on the arm of the wearer of the apparatus 100.

The apparatus 100 includes a plurality of electromechanical actuators 124, 125, 127 wherein each actuator of the plurality of actuators 124, 125, 127 is operatively coupled to the joint assembly 118. Actuator 125 is operatively coupled to support frame 116, and actuator 127 is operatively coupled to support frame 112. The actuators 124, 125, 127 are configured to generate mechanical lifting assistance in coordination with the arm movement of the wearer of the apparatus 100.

The apparatus 100 includes an electronic control module (ECM) 126 configured to be in electrical communication with other components of the apparatus 100. Preferably, the electronic control module 126 is removably placed along the harness strap member 102. The ECM 126 enables manual or automatic (i.e., autonomous) activation of the apparatus 100 and includes a rechargeable battery pack for providing power to the apparatus 100. The ECM 126 continuously monitors arm movement of the user and load pressure to coordinate actuator assistance as described later in the disclosure. The ECM 126 can be modified, so that all sensors are distributed throughout the lifting apparatus 100, without the need for an extra entity, the ECM 126, on the body.

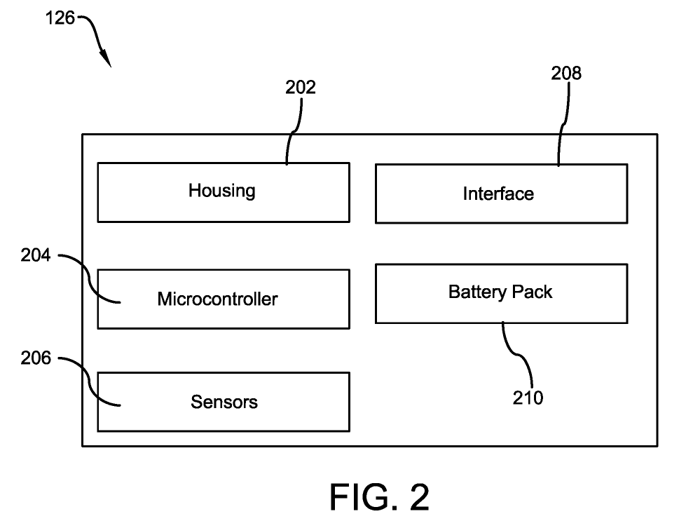

FIG. 2 illustrates an embodiment of the electronic control module, which forms the central processing and power distribution mechanism of the lifting-assist device of the present invention in accordance with the disclosed structure. The ECM 126 is configured to receive input signals from various sensors, process those signals through an embedded controller, and transmit appropriate control signals to one or more actuators associated with the device 100. Specifically, the ECM 126 includes a housing 202, which encloses the electronic components thereof. The housing 202 may be fabricated from a lightweight, durable material such as a polymer composite or anodized aluminum to protect against impact, heat, and environmental exposure.

A microcontroller 204 is configured to serve as the processing unit of the ECM 126. The microcontroller 204 receives input signals from various sensors located on the device (as shown in FIG. 1) and executes control algorithms that determine the appropriate actuation output of the actuators 124, 125, 127. The microcontroller 204 can include a digital signal processor (DSP) or embedded CPU to manage real-time motion control, power regulation, and feedback processing.

A plurality of sensors 206 including strain gauges, load cells, or position encoders are included in the ECM 126 and are configured to monitor key operational and biomechanical parameters of the apparatus 100, such as angular displacement, torque, strain, acceleration, and load distribution. The sensors 206 generate analog or digital signals that are communicated to the microcontroller 204 for analysis and system response. It should be noted that the sensors 122 (FIG. 1) can be the same or different from the sensors 206 and are also communicatively coupled to the ECM 126.

An interface 208 functions as the communication link between a user and the ECM 126. The interface 208 can include one or more of control buttons, a touch interface, LED indicators, wireless connectivity (such as Bluetooth or Wi-Fi), or wired communication ports. Using the interface 208, the user can activate or deactivate the apparatus 100 and monitor device status.

A battery pack 210 provides the electrical power to the ECM 126 and other electronic components of the apparatus 100. The battery pack 210 can include rechargeable lithium-ion cells with integrated power management circuitry to provide stable voltage supply, overcurrent protection, and efficient energy utilization.

In operation, the microcontroller 204 is electrically coupled to the sensors 206, the interface 208, and the battery pack 210. The microcontroller 204 receives data signals from the sensors and transmits control signals to the actuators (shown in FIG. 1) to drive the lifting. In some embodiments, the ECM 126 is further configured to interrupt power supply to the actuators in case of overload or system fault detection and maintain operating temperature for electronic components.

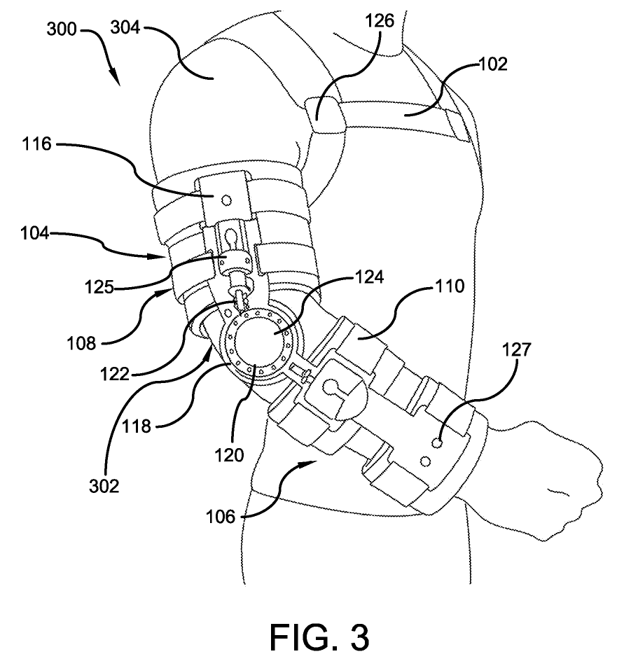

FIG. 3 illustrates a perspective view of the electronic assistive lifting apparatus of the present invention being worn by a wearer for lifting heavy objects with minimal muscular effort. As depicted, the apparatus 100 is in the form of a wearable exoskeleton system configured to support the arms 302 and shoulders 304 of a user or wearer 300, transferring the lifting force from the muscles of the user 300 to the apparatus 100. The harness strap member 102 is adapted to be worn about the upper torso of a user or wearer. The harness strap member 102 distributes load forces evenly across the torso of the wearer 300. The harness strap member 102 is preferably adjustable and breathable to provide comfort during prolonged use while maintaining structural stability during lifting operations.

The arm-assist module 104 comprises the upper arm brace 108 and the forearm brace 106 which are formed of rigid or semi-rigid support frames 116, 112 respectively. Both braces 106 and 108 are secured to the arm 302 of the user 300 by a plurality of adjustable straps 110 and 114, providing a snug and ergonomic fit. The support frames 112, 116 are dimensioned and contoured to conform to the anatomy of the arm 302 of the wearer 300, thereby enabling a natural range of motion.

The joint assembly 118 includes a rotational hinge 120, which enables smooth articulation of the arm during flexion and extension. The joint assembly 118 further incorporates one or more sensors 122, which are configured to detect parameters such as angular displacement, motion direction, and load force applied by the arm 302 of the user 300. The data generated by the sensors 122 are transmitted to the electronic control module 126 for real-time processing and actuation control.

In operation, when the user 300 initiates a lifting motion, the sensors 122 and 206 (FIG. 2) detect the movement and transmit corresponding data to the microcontroller 204 housed within the ECM 126. The ECM processes the input and activates the actuators 124, which provide torque at the joint assembly 118 to assist the user in elevating the object. The actuators provide synchronized assistive motion, wherein the apparatus 100 effectively reduces the biomechanical load experienced by arm muscles of the user 300.

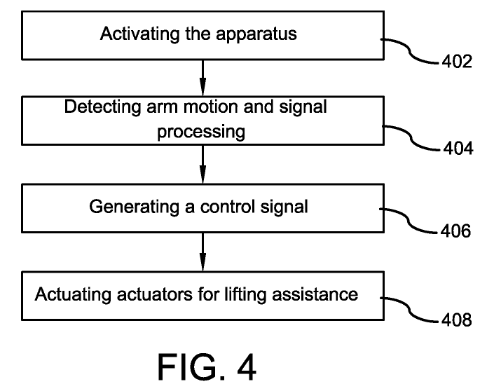

FIG. 4 illustrates a flow diagram depicting the operational sequence of the electronic assistive lifting apparatus, according to one embodiment of the present invention. Initially, the apparatus 100 is activated by a user (Step 402). The activation may occur manually by a user through an input on the interface of the ECM 126, or automatically in response to motion detection. Upon activation, the ECM 126 performs an initialization routine that includes powering the sensors, establishing baseline parameters, and conducting system diagnostics.

In step 404, the apparatus 100 detects arm motion and processes the detection signal. As the user initiates arm movement or begins a lifting action, one or more of the sensors embedded within the joint assembly, arm braces, and ECM detect parameters such as angular displacement, load, and acceleration. The sensors convert the physical parameters into electrical signals that are transmitted to the microcontroller 204 within the ECM 126. The ECM then performs signal conditioning and data analysis, filtering noise and interpreting the motion data to determine user intent and lifting dynamics.

At step 406, the ECM 126 executes generating a control signal. Based on the processed motion data, the microcontroller 204 calculates the actuation required of actuator for assistance. The ECM may utilize embedded control algorithms such as PID (Proportional-Integral-Derivative) or load-adaptive feedback control, to generate control signals corresponding to the torque and force needed to assist the motion. It should be noted that the control signal is dynamically adjusted in real time according to changes in the motion speed, angle, and load weight.

Accordingly, the ECM 126 actuates the actuators for lifting assistance (Step 408). Upon receiving the control signals, the actuators 124 positioned along the support frames 112, 116 and connected through the joint assembly 118 are actuated to provide mechanical lifting assistance. The actuators generate a proportional lifting force synchronized with the natural arm movement of the wearer/user, effectively reducing the muscular load experienced by the user.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “electronic assistive lifting apparatus”, “lifting-assist device”, “apparatus”, and “device” are interchangeable and refer to the electronic assistive lifting apparatus 100 of the present invention.

Notwithstanding the forgoing, the electronic assistive lifting apparatus 100 of the present invention can be of any suitable configuration as is known in the art without affecting the overall concept of the invention, provided that it accomplishes the above stated objectives. One of ordinary skill in the art will appreciate that the electronic assistive lifting apparatus 100 shown in the FIGS. are for illustrative purposes only, and that many other configurations of the electronic assistive lifting apparatus 100 are well within the scope of the present disclosure. Although the dimensions of the electronic assistive lifting apparatus 100 are important design parameters for user convenience, the electronic assistive lifting apparatus 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An electronic limb assistive lifting apparatus comprising:
a harness strap member;
an arm-assist module;
a forearm brace;
an upper arm brace;
a joint assembly;
a plurality of support frames; and
a rotational hinge;
wherein said harness strap member comprising high-tensile materials to distribute load forces evenly across an upper body of the wearer of the apparatus;
wherein said arm-assist module is operatively connected to said harness strap member and is configured to be positioned along the arm of the wearer;
wherein said arm-assist module comprises said forearm brace and said upper arm brace;
wherein said forearm brace comprises an adjustable forearm strap and a forearm support frame;
wherein said upper arm brace comprises an adjustable upper arm strap and an upper arm support frame;
wherein said joint assembly is disposed between said forearm support frame and said upper arm support frame;
wherein said joint assembly is disposed proximally to the elbow region of the wearer of the apparatus; and
further wherein said joint assembly comprises said rotational hinge to enable rotational movement of said forearm support frame relative to said upper arm support frame.

2. The electronic limb assistive lifting apparatus of claim 1, wherein said joint assembly comprises a plurality of sensors configured to detect angular displacement and applied load pressure on the arm of the wearer of the apparatus.

3. The electronic limb assistive lifting apparatus of claim 2 further comprising a plurality of electromechanical actuators, wherein each of said plurality of electromechanical actuators is operatively coupled to said joint assembly to generate mechanical lifting assistance in coordination with the arm movements of the wearer of the apparatus.

4. The electronic limb assistive lifting apparatus of claim 3, wherein an upper arm actuator is operatively coupled to said upper arm support frame and a forearm actuator is operatively coupled to said forearm support frame.

5. The electronic limb assistive lifting apparatus of claim 4 further comprising an electronic control module (ECM) configured to be in electrical communication with said arm-assist module, wherein said ECM is removably positioned along said harness strap member.

6. The electronic limb assistive lifting apparatus of claim 5, wherein said ECM continuously monitors the arm movements of the wearer of said arm-assist module and said applied load pressure on the arm of the wearer of the apparatus.

7. The electronic limb assistive lifting apparatus of claim 6, wherein said ECM receives input signals from said plurality of sensors, processes said input signals through an embedded controller, and transmits control signals to said plurality of electromechanical actuators.

8. The electronic limb assistive lifting apparatus of claim 7 further comprising a microcontroller configured to serve as the processing unit of said ECM, wherein said microcontroller receives said input signals from said plurality of sensors and executes control algorithms for determining actuation output of said plurality of electromechanical actuators.

9. The electronic limb assistive lifting apparatus of claim 8, wherein said plurality of sensors selected from the group consisting of strain gauges, load cells, and position encoders for monitoring biomechanical parameters.

10. The electronic limb assistive lifting apparatus of claim 9, wherein said biomechanical parameters selected from the group consisting of angular displacement, torque, strain, acceleration, and load distribution.

11. The electronic limb assistive lifting apparatus of claim 10 further comprising an interface communication link between said arm-assist module and said ECM, wherein said interface communication link comprises one or more selected from the group consisting of control buttons, a touch interface, LED indicators, wireless connectivity, and wired communication ports.

12. An electronic limb assistive lifting apparatus comprising:
a strap member;
an arm-assist module;
a forearm brace;
an upper arm brace;
a joint assembly;
a plurality of support frames;
a rotational hinge; and
an electronic control module (ECM);
wherein said strap member comprising high-tensile materials to distribute load forces evenly across an upper body of the wearer of the apparatus;
wherein said arm-assist module is operatively connected to said strap member and is configured to be positioned along the arm of the wearer;
wherein said arm-assist module comprises said forearm brace and said upper arm brace;
wherein said forearm brace comprises an adjustable forearm strap and a forearm support frame;
wherein said upper arm brace comprises an adjustable upper arm strap and an upper arm support frame;
wherein said joint assembly is disposed between said forearm support frame and said upper arm support frame;
wherein said joint assembly is disposed proximally to the elbow region of the wearer of the apparatus;
wherein said joint assembly comprises said rotational hinge to enable rotational movement of said forearm support frame relative to said upper arm support frame;
wherein said electronic control module configured to be in electrical communication with said arm-assist module;
wherein said joint assembly comprises a plurality of sensors configured to detect angular displacement and applied load pressure on the arm of the wearer of the apparatus; and
further wherein said ECM continuously monitors the arm movements of the wearer of said arm-assist module and said applied load pressure on the arm of the wearer of the apparatus.

13. The electronic limb assistive lifting apparatus of claim 12 further comprising a plurality of electromechanical actuators, wherein each of said plurality of electromechanical actuators is operatively coupled to said joint assembly to generate mechanical lifting assistance in coordination with the arm movements of the wearer of the apparatus.

14. The electronic limb assistive lifting apparatus of claim 13, wherein said ECM receives input signals from said plurality of sensors, processes said input signals through an embedded controller, and transmits control signals to said plurality of electromechanical actuators.

15. The electronic limb assistive lifting apparatus of claim 14 further comprising a microcontroller configured to serve as the processing unit of said ECM, wherein said microcontroller receives said input signals from said plurality of sensors and executes control algorithms for determining actuation output of said plurality of electromechanical actuators.

16. The electronic limb assistive lifting apparatus of claim 15, wherein said plurality of sensors selected from the group consisting of strain gauges, load cells, and position encoders for monitoring biomechanical parameters.

17. The electronic limb assistive lifting apparatus of claim 16, wherein said biomechanical parameters selected from the group consisting of angular displacement, torque, strain, acceleration, and load distribution.

18. A method of assisting in limb mobility, the method comprising the steps of:
providing a harness strap member, a limb-assist module, a joint assembly, a plurality of support frames, a rotational hinge, and an electronic control module (ECM);
mounting said harness strap member across an upper body of the wearer of the apparatus;
operatively connecting said limb-assist module to said harness strap member, wherein said limb-assist module is configured to be positioned along the limb of the wearer;
wherein said limb-assist module comprises a lower limb brace and an upper limb brace;
wherein said lower limb brace comprises an adjustable lower limb strap and a lower limb support frame;
wherein said upper limb brace comprises an adjustable upper limb strap and an upper limb support frame;
operatively connecting said joint assembly between said lower limb support frame and said upper limb support frame, wherein said joint assembly is disposed proximally to a joint region of the wearer of the apparatus;
wherein said joint assembly comprises said rotational hinge to enable rotational movement of said lower limb support frame relative to said upper limb support frame;
electrically communicating said electronic control module with said limb-assist module; and
further wherein said joint assembly comprises a plurality of sensors configured to detect angular displacement and applied load pressure on the limb of the wearer of the apparatus.

19. The method of assisting in limb mobility of claim 18 further comprising a step of continuously monitoring the limb movements of the wearer of said limb-assist module with said ECM, wherein said continuously monitoring the limb movements of the wearer of said limb-assist module comprises said applied load pressure on the limb of the wearer of the apparatus.

20. The method of assisting in limb mobility of claim 19, further comprising a step of interfacing a communication link between said limb-assist module and said ECM, wherein said interface communication link comprises one or more selected from the group consisting of control buttons, a touch interface, LED indicators, wireless connectivity, and wired communication ports.
